(19) United States
(12) Patent Application Publication
(10) Pub. No.: US 2010/0300067 A1
(43) Pub. Date: Dec. 2, 2010

(54) COMPONENT CONFIGURED FOR BEING SUBJECTED TO HIGH THERMAL LOAD DURING OPERATION

(75) Inventor: Arne Boman, (US)

Correspondence Address: WRB-IP LLP, 801 N. Pitt Street, Suite 123, ALEXANDRIA, VA, 22314, US

(73) Assignee: Volvo Aero Corporation, Trollhattan (SE)

(21) Appl. No.: 12/809,609

(22) PCT Filed: Aug. 27, 2008
(86) PCT No.: PCT/SE08/00481

§ 371 Date: Aug. 18, 2010

(30) Foreign Application Priority Data
Dec. 21, 2007 (SE) 0702896-2

(51) Int. Cl. F02K 9/64; F02K 9/97

(52) U.S. Cl. 60/267; 60/770

(57) ABSTRACT

A component configured for being subjected to a high thermal load during operation includes a wall structure with a tubular shape, wherein the wall structure includes a plurality of cooling channels for handling a coolant flow. The wall structure is divided in a plurality of sectors in a circumferential direction of the wall structure. Each sector includes at least two cooling channels and the wall structure is configured to prevent coolant flow communication between the cooling channels in adjacent sectors.

### BACKGROUND AND SUMMARY

The present invention relates to a component configured for being subjected to a high thermal load during operation, comprising a wall structure with a tubular shape, wherein the wall structure comprises a plurality of cooling channels for handling a coolant flow.

The component will in the following be described for being used as a rocket engine component. This application should be regarded as preferred. However, also other applications are possible, such as for a jet motor or a gas turbine.

The component is in operation actively cooled by a coolant flowing in said cooling channels. The coolant may further be used for combustion after having served as a coolant. The present invention is specifically designed for a regeneratively cooled liquid fuel rocket engine.

The rocket engine component in question forms a part of a combustion chamber and/or a nozzle for expansion of the combustion gases. The combustion chamber and the nozzle are together commonly referred to as a thrust chamber.

During operation, a rocket engine component forming a combustion chamber and/or an outlet nozzle is subjected to very high stresses. A nozzle is for example subjected to a very high temperature on its inside (in the magnitude of 800 0 K) and a very low temperature on its outside (in the magnitude of 50 0 K). As a result of this high thermal load, stringent requirements are placed upon the choice of material, design and manufacture of the nozzle. At least there is a need for an effective cooling of the nozzle.

The wall structure forming the nozzle has a tubular shape with a varying diameter along a centre axis. More specifically, the outlet nozzle wall structure has a conical or parabolic shape. The outlet nozzle normally has a diameter ratio from the aft or large outlet end to the forward or small inlet end in the interval from 2:1 to 4:1.

During engine operation, any cooling medium may be used to flow through the cooling channels. Regarding a rocket engine, the rocket engine fuel is normally used as a cooling medium in the outlet nozzle. The rocket engine may be driven with hydrogen or a hydrocarbon, i.e. kerosene, as a fuel. Thus, the fuel is introduced in a cold state into the wall structure, delivered through the cooling channels while absorbing heat via the inner wall and is subsequently used to generate the thrust. Heat is transferred from the hot gases to the inner wall, further on to the fuel, from the fuel to the outer wall, and, finally, if the nozzle is operating within the atmosphere, from the outer wall to any medium surrounding it. Heat is also transported away by the coolant as the coolant temperature increases by the cooling. The hot gases may comprise a flame generated by combustion of gases and/or fuel.

One known rocket engine nozzle is of the channel wall type where the cooling channels are milled in a sheet and the top wall is either welded or brazed to the radially projecting division walls (mid walls). In a further known nozzle design, the cooling channels are defined by tubes arranged in a side-by-side relationship. The nozzle design with milled channels is cost-efficient relative to the nozzle design with tubes. However, one drawback with milled channels is that there will be a variation in cross section channel area relative to the nozzle design with tubes. The potential problem with a variation in cooling channel area is that the cooling mass flow may vary from channel to channel thus creating different wall temperatures and thereby different expected life.

It is desirable to achieve a component configured for being subjected to a high thermal load during operation, which creates conditions for a long life and and a cost-efficient production The component should be especially suitable for a rocket engine.

According to an aspect of the present invention, a wall structure is divided in a plurality of sectors in a circumferential direction of the wall structure, that each sector comprises at least two cooling channels and that the wall structure is configured to prevent coolant flow communication between the cooling channels in adjacent sectors.

More specifically, this design creates conditions for a low variation in mass flow between the channels. The solution is especially applicable for a channel wall type where the cooling channels are milled in a sheet and the top wall is attached to the radially projecting division walls. The mass flow in a cooling channel depends on the pressure drop. By virtue of the division in several sectors of the component, a total pressure drop comprises not only the pressure drop in the cooling channel, but also the pressure drop in the inlet manifold and/or the outlet manifold.

Further, the effect of a leak in a cooling channel is reduced due to the division in several sectors of the component. If a leak opens up in a cooling channel, the effect of a leakage will be reduced to the sector in which the leakage took place, leaving all other sectors unaffected by the leakage. In this manner the effect of the leakage will be kept local (within the sector), and the global function of the nozzle is guaranteed.

According to a preferred embodiment of the invention, a partition at a cooling channel end is adapted to prevent coolant flow communication between adjacent sectors. This design creates conditions for a cost-efficient production. Preferably, the partition is configured to bridge a gap between a division wall separating two channels in adjacent sectors and an end wall. Preferably, the wall structure is configured for flow communication between the cooling channels within each sector at both an inlet end and an end of the cooling channels opposite an inlet end.

Further, the wall structure is configured for turning the coolant flow at the cooling channel end opposite the inlet end in order to flow in opposite directions in the channels. In other words, a turning manifold is arranged at the cooling channel end opposite the inlet end.

In other words, partitions (bulk heads) arc introduced in at least one of the inlet manifold and the turning manifold of a channel wall rocket nozzle. With this design, the pressure drop that sets the channel mass flow is not just the cooling channel pressure drop but instead the sum of the inlet manifold pressure drop, the channel pressure drop and the outlet manifold pressure drop. Thus, the channel mass flow becomes dependant of the manifold pressure drop as well. In this manner, the effect of a channel pressure drop variation is smeared and the mass flow is not affected as much as if the mass flow is set by the channel pressure drop only.

Further preferred embodiments and advantages will be apparent from the following description and drawings.

### BRIEF DESCRIPTION OF THE DRAWINGS

The invention will be explained below, with reference to the embodiments shown on the appended drawings, wherein

FIG 1 schematically shows a first embodiment of a rocket engine thrust chamber in a side view,

FIG 2 shows a cut view of the wall structure of the component according to FIG. 1, and

FIG 3 shows the nozzle from FIG. 1 in a schematic, perspective view.

### DETAILED DESCRIPTION

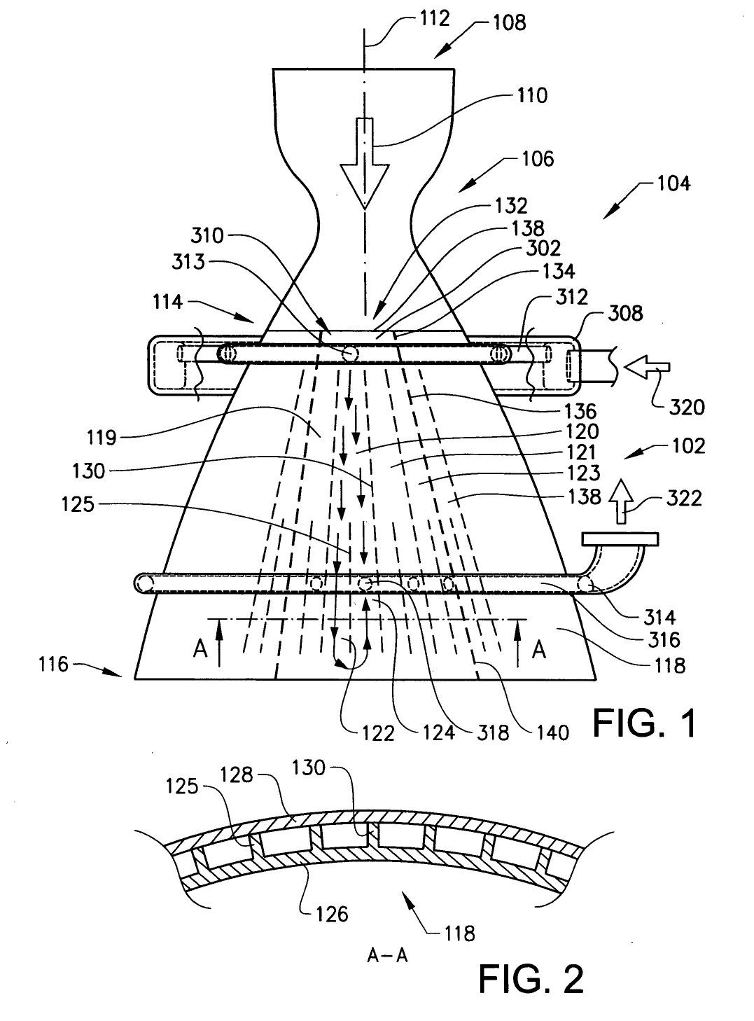

FIG. 1 schematically shows a component 102 configured for being subjected to a high thermal load during operation. More specifically, the component 102 is configured to form a rocket engine component, especially a liquid fuel rocket engine component and particularly a regeneratively cooled rocket engine component in the form of an outlet nozzle. Further, FIG. 1 shows a rocket engine thrust chamber 104 comprising a combustion chamber 106 and the nozzle 102, which is attached to the combustion chamber directly downstream of the combustion chamber 106.

The component 102 has an annular shape defining an inner space 108 for gas flow, see arrow 110. More specifically, the component 102 has a tubular shape. The component 102 has a rotary symmetrical shape with regard to a centre axis 112. The component 102 defines an upstream end 114 for entrance of the gas flow and a downstream end 116 for exit of the gas flow. More specifically, the component 102 has a circular cross section, wherein a cross section diameter continuously increases in an axial direction 112 of the component from the upstream end 114 towards the downstream end 116.

The component 102 comprises a load bearing wall structure 118 with cooling channels 119,120,121,123 adapted for handling a coolant flow. Generally, the cooling channels are arranged at least substantially in parallel to one another. The cooling channels 119,120,121,123 are arranged in a side-by-side relationship. Further, the cooling channels are arranged in a diverging manner from the upstream end 114 towards the downstream end 116.

The cooling channels generally extend along the contour of the component 102 between the upstream end 114 and the downstream end 116. The cooling channels extend in such a direction that a projection of the cooling channel on the centre axis 112 of the component 102 is in parallel with the centre axis 112.

FIG. 2 shows a cross section A-A of the wall structure 118 in FIG. 1. The wall structure 118 comprises an inner wall 126 and an outer wall 128 and a plurality of elongated webs 130 (or division walls) adapted to connect the inner wall 126 to the outer wall 128 dividing the space between the walls into a plurality of cooling channels. Thus, the cooling channels are separated in the circumferential direction by said division wall 130.

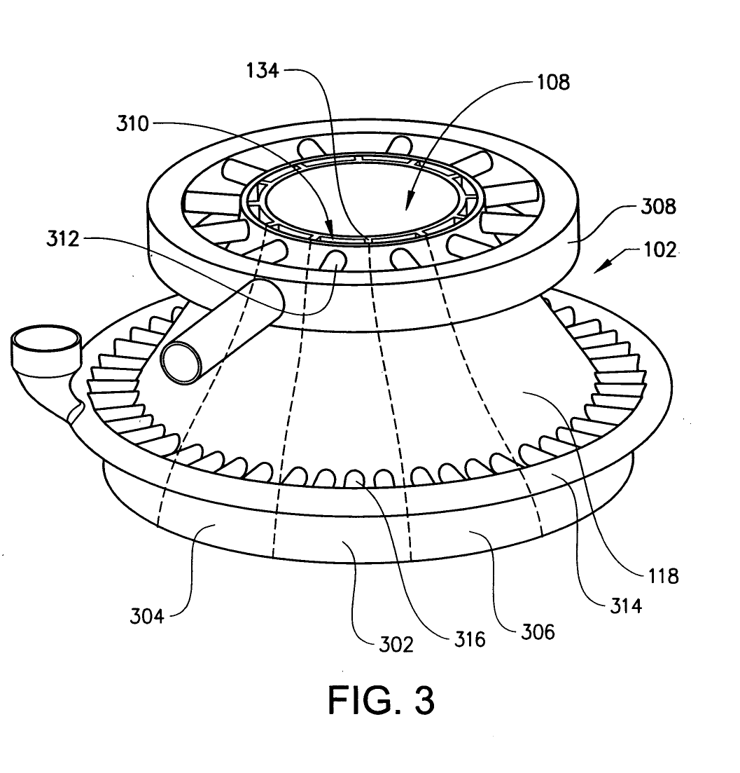

Referring now to FIG. 1 and 3. The wall structure 118 is divided in a plurality of sectors 302,304,306 in a circumferential direction of the wall structure. Each sector comprises at least two adjacent cooling channels 119,120,121,123. The wall structure is configured to prevent coolant flow communication between the cooling channels in adjacent sectors 302,306. More precisely, a partition 134 at an upstream end of a cooling channel 123 is adapted to prevent coolant flow communication between adjacent sectors. The partition 134 is configured to bridge a gap between a division wall 136 separating two channels 123,138 in adjacent sectors 302,306 and an end wall 138. The end wall 138 is formed by a transverse wall extending in a circumferential direction of the wall structure and projecting in a radial direction from the inner wall 126.

In a similar way, a partition 140 at a downstream end of the cooling channel is adapted to prevent coolant flow communication between adjacent sectors.

Further, the wall structure 118 is configured for flow communication between the cooling channels 119,120,121,123 within each sector. More precisely, the cooling channels 119,120,121,123 within each sector are in flow communication with each other at an inlet end 114 of the cooling channels.

Each upstream cooling channel 120 is divided into two downstream cooling channels 122,124 at a position between the inlet end 114 and the outlet end 116 by means of a further division wall 125.

Further, the cooling channels 122,124 within each sector are in flow communication with each other at an end 116 of the cooling channels opposite an inlet end. More precisely, the wall structure is configured for turning the coolant flow at the cooling channel end 116 opposite the inlet end 114 in order to flow in opposite directions in part of the channels 122,124.

An annular outer chamber 308, or outer torus, is positioned around the wall structure 118. An inner chamber 310 in each sector is in flow communication with all the cooling channels 119,120,121,123 in the sector 302 at the upstream end. More specifically, the cooling fluid chamber is formed in the region between the ends of the division walls within a specific sector 302 and the transverse wall. At least one inlet passage 312 is adapted for entrance of the coolant from the outer chamber 308 to the inner chamber 310 in each sector. A port 313 through the outer wall 128 is connected to the inlet passage 312.

Further, an annular outlet chamber 314, or torus, is positioned around the wall structure and at least one outlet passage 316 is adapted for exiting the coolant from the cooling channels 124 to the annular outlet chamber 314. A port 318 through the outer wall 128 is connected to the outlet passage 316. More specifically, a plurality of ports 318 are connected to each single outlet passage 316. A small annular manifold (not shown) is preferably arranged around the wall 128 for distributing the flow from said plurality of ports 318 into the single outlet passage 316. This small annular manifold preferably also comprises sector divisions via partition walls (bulk heads) The outlet port 318 is positioned at a distance from the outlet end 116, see FIG. 1. The port 318 is further positioned in one of said channels 124. The coolant will flow downstream in both channels 122,124 to the position of the outlet port 318 and continue passed the position of the outlet port in only one of the channels.

The arrows 320, 322 indicate the coolant flow direction to and from the wall structure, respectively.

The inner wall 126 and the division walls, or webs, 130 may be formed in one piece, preferably by milling. The top wall 132 is positioned around the inner wall and either welded or brazed to the division walls 130.

The invention is not in any way limited to the above described embodiments, instead a number of alternatives and modifications are possible without departing from the scope of the following claims.

Although the invention has been described above for a rocket engine, also other applications are feasible, like in a wall in an aircraft engine. A further application is feasible where the component does not have to be continuous in the circumferential direction or circular. Thus, the invention may be applied in a curved, or substantially flat application. Further, a plurality of such flat parts may be joined to form a component with a polygonal cross section.

Further, regarding the cooling channel configuration is not limited to straight channels. Instead, the cooling channels may for example be arranged to extend along a helical curve.

According to a further alternative to the embodiment shown in FIG. 1, the coolant flow direction to and from the wall structure may switch places.

1. A component configured for being subjected to a high thermal load during operation, comprising a wall structure with a tubular shape, wherein the wall structure comprises a plurality of cooling channels for handling a coolant flow, characterized in that wherein the wall structure is divided in a plurality of sectors in a circumferential direction of the wall structure, that each sector comprises at least two cooling channels and that the wall structure is configured to prevent coolant flow communication between the cooling channels in adjacent sectors.

2. A component according to claim 1, wherein a partition at a cooling channel end is adapted to prevent coolant flow communication between adjacent sectors.

3. A component according to claim 2, wherein the partition is configured to bridge a gap between a division wall separating two channels in adjacent sectors and an end wall.

4. A component according to claim 1, wherein the wall structure is configured for flow communication between the cooling channels within each sector.

5. A component according to claim 4, wherein the cooling channels within each sector are in flow communication with each other at an inlet end of the cooling channels.

6. A component according to claim 5, wherein the cooling channels within each sector are in flow communication with each other at an end of the cooling channels opposite an inlet end.

7. A component according to claim 6, wherein the wall structure is configured for turning the coolant flow at the cooling channel end opposite the inlet end in order to flow in opposite directions in the channels.

8. A component according to claim 1, wherein the component comprises an annular outer chamber positioned around the wall structure, an inner chamber in each sector in flow communication with all the cooling channels in the sector and at least one inlet passage for entrance of the coolant from the outer chamber to the inner chamber in each sector.

9. A component according to claim 1, wherein the component comprises an annular outlet chamber positioned around the wall structure and at least one outlet passage for exiting the coolant from the cooling channels to the annular outlet chamber.

10. A component according to claim 1, wherein the cooling channels are arranged at least substantially in parallel to one another.

11. A component according to claim 1, wherein the cooling channels are arranged in a diverging manner.

12. A component according to claim 1, wherein the component defines an inner space for gas flow.

13. A component according to claim 12, wherein the component defines an upstream end for entrance of the gas flow and a downstream end for exit of the gas flow and that the cooling channels extend between the upstream end and the downstream end.

14. A component according to claim 1, wherein the component has a rotary symmetrical shape with regard to a centre axis.

15. A component according to claim 1, wherein the component has a circular cross section, that a cross section diameter varies in an axial direction of the component and that the cooling channels extend along the contour of the component.

16. A component according to claim 1, wherein at least one of the cooling channels extend in such a direction that a projection of the cooling channel on a centre axis of the component is in parallel with the centre axis.

17. A component according to claim 1, wherein the wall structure is configured to be load bearing.

18. A component according to claim 1, wherein the component is configured to form a rocket engine component.

19. A component according to claim 1, wherein the component is configured to form a liquid fuel rocket engine component.

20. A component according to claim 18, wherein the rocket engine component is adapted for a regeneratively cooled rocket engine.
